(19) United States
(12) Patent Application Publication
(10) Pub. No.: US 2014/0006152 A1
(43) Pub. Date: Jan. 2, 2014

(54) Providing a Proximity Triggered Response in a Video Display

(71) Applicants: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(72) Inventors: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(21) Appl. No.: 13/710,053

(22) Filed: Dec. 10, 2012

Related U.S. Application Data
(60) Provisional application No. 61/569,105, filed on Dec. 9, 2011.

(51) Int. Cl. G06Q 30/02

(52) U.S. Cl. CPC G06Q 30/0269
USPC 705/14.53; 705/14.66

(57) ABSTRACT

The present invention relates to advertising in stores through the use of video displays that can present customized advertisements when a customer is recognized as being in proximity to the video display. Video displays can be used in stores to display customizable advertisements of a particular vendor. These advertisements can be selectively modified, personalized, and/or customized for a particular customer when that customer is recognized as being in proximity to the video display. This recognition can use the customer's mobile communication device, such as a cell phone, which can be recognized by the system as being in proximity to the video display. This recognition can also read information from a user's identification card, such as a loyalty card, in proximity to the video display. Customized content can be moved from one display to another as the customer moves through a store.

### CROSS-REFERENCE TO RELATED APPLICATIONS

This application claims priority to U.S. Provisional Patent Application No. 61/569,105 which was filed on Dec. 9, 2011 and titled “Systems And Methods For Providing A Proximity Triggered Response In A Video Display.”

### BACKGROUND

The importance of point-of-purchase advertising in retail environments that display items on shelves is well known in the art. Indeed, manufacturers and merchants both employ a wide variety of advertising techniques to attract and entice customers to purchase items that are stored and displayed on shelves. Because the shelf displaying or storing a product is often the last decision point in a buying decision, the ability to influence a customer's last decisive moments before the customer leaves the shelf often depends on the ability of the display to catch the customer's attention.

Currently, there are several ways in which manufactures and merchants try to catch a customer's attention at the point of purchase. For example, as a way to attract attention, some manufacturers and merchants have placed static advertisements in close proximity to a target product, where a target product is a product for which the advertisements are used to increase sales. These static advertisements often rely on artistry, color, advertised price, shelf location, and/or the like to attract customers. Although some of these static advertisements may be disposed flush with a shelf, some people have found that placing advertisements perpendicular to the shelving may be more effective at catching customer's attention. In another example of how some current point-of-purchase advertising may try to catch customer attention and influence sales, some have incorporated blinking lights with their otherwise static displays.

However, some of the current point-of-purchase advertising apparatuses, systems, and methods may have some shortcomings In one example of a shortcoming common to some retail-shelf point-of-purchase advertising, some displays (i.e., video and static displays) may be placed in aisles in a manner that makes navigating the aisles more inconvenient. Similarly, in another example, some displays may become damaged or may even hurt a customer if the customer (or other object) should unintentionally strike the display. In still another example, some aisles may have too many displays or displays that are too close together. Such displays may tend to clutter an aisle and result in sub-optimal sales.

### BRIEF SUMMARY

The present invention extends to methods, systems, and computer program products for advertising in retail environments (herein simply “stores”). More specifically, this application relates to systems and methods for advertising in stores through the use of video displays that can present customized advertisements when a customer is recognized as being in proximity to the video display.

Video displays can be used in stores to display customizable advertisements of a particular vendor. These advertisements can be selectively modified, personalized, and/or customized (herein simply “customized”) for a particular customer when that customer is recognized as being in proximity to the video display. This recognition can use the customer's mobile communication device, such as a cell phone, which can be recognized by the system as being in proximity to the video display. This recognition can also read information from a user's identification card, such as a loyalty card, in proximity to the video display.

In one embodiment, the present invention comprises a method for displaying customized content on a display in a retail outlet. A customer is detected as being within a specified proximity of a display located in a retail outlet. Content to be displayed on the display is identified. One or more attributes of the customer are also identified. The content to be displayed is customized using the one or more attributes. Then, the customized content is displayed on the display while the customer is within the specified proximity of the display.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer system that can be used to implement the present invention;

FIGS. 2-4 illustrate exemplary configurations of displays on shelves of a retail outlet; and

FIG. 5 illustrates a flowchart of an exemplary method for displaying customized content on a display in a retail outlet.

### DETAILED DESCRIPTION

The present invention extends to methods, systems, and computer program products for advertising in retail environments (herein simply “stores”). More specifically, this application relates to systems and methods for advertising in stores through the use of video displays that can present customized advertisements when a customer is recognized as being in proximity to the video display.

Video displays can be used in stores to display customizable advertisements of a particular vendor. These advertisements can be selectively modified, personalized, and/or customized (herein simply “customized”) for a particular customer when that customer is recognized as being in proximity to the video display. This recognition can use the customer's mobile communication device, such as a cell phone, which can be recognized by the system as being in proximity to the video display. This recognition can also read information from a user's identification card, such as a loyalty card, in proximity to the video display.

In one embodiment, the present invention comprises a method for displaying customized content on a display in a retail outlet. A customer is detected as being within a specified proximity of a display located in a retail outlet. Content to be displayed on the display is identified. One or more attributes of the customer are also identified. The content to be displayed is customized using the one or more attributes. Then, the customized content is displayed on the display while the customer is within the specified proximity of the display.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

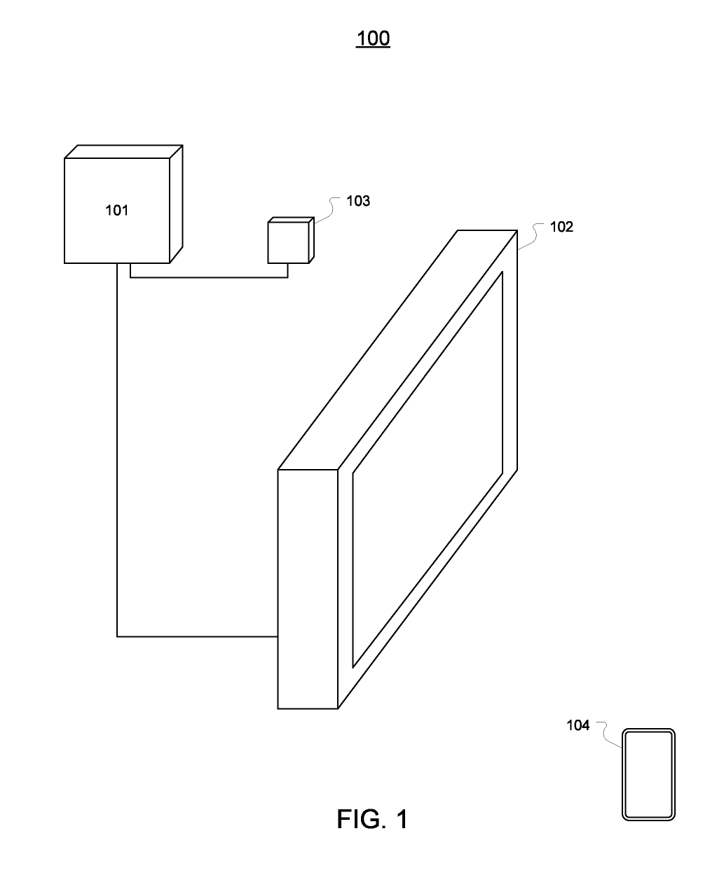

FIG. 1 illustrates an exemplary computer environment 100 in which the present invention can be implemented. Computer environment 100 includes computer system 101 that is connected to a display 102 and a proximity sensor 103. Proximity sensor detects detectable item 104 when it is within a specified proximity of display 102.

Computer system 101 can represent any type or number of computing devices such as one or more servers which can be connected to any number of other computer systems (e.g. via the internet or other network). Computer system 101 can be located completely or partially within a store, completely or partially in the cloud, or at any other location or locations that would allow computer system 101 to provide content to display 102.

Display 102 can comprise any type of display device capable of dynamically displaying visual content. For example, display 102 can represent a flat screen display used to display videos. Display 102 can also be configured to output audio. Display 102 can be configured to mount to any type of shelving or other support structure to allow the display to be positioned at virtually any location within a store.

Proximity sensor 103 can be any type of sensor capable of detecting when an item is within a specified proximity of display 102. For example, detectable item 104 can be a mobile phone whose proximity is detected via various means such as near field communication, Wi-Fi, GPS, Bluetooth, Infrared, etc. Also, detectable item 104 can be a card containing information that is detectable by sensor 103 such as a loyalty, credit, or other card that contains a bar code, magnetically encoded data, an RFID tag, or other type of detectable means.

Display 102 and/or proximity sensor 103 can be connected to computer system 101 in any manner including wired and wireless connections. As further described below, when a customer is detected, via sensor 103, as being within a specified proximity of display 102, computer system 101 can cause customized content to be displayed on display 102.

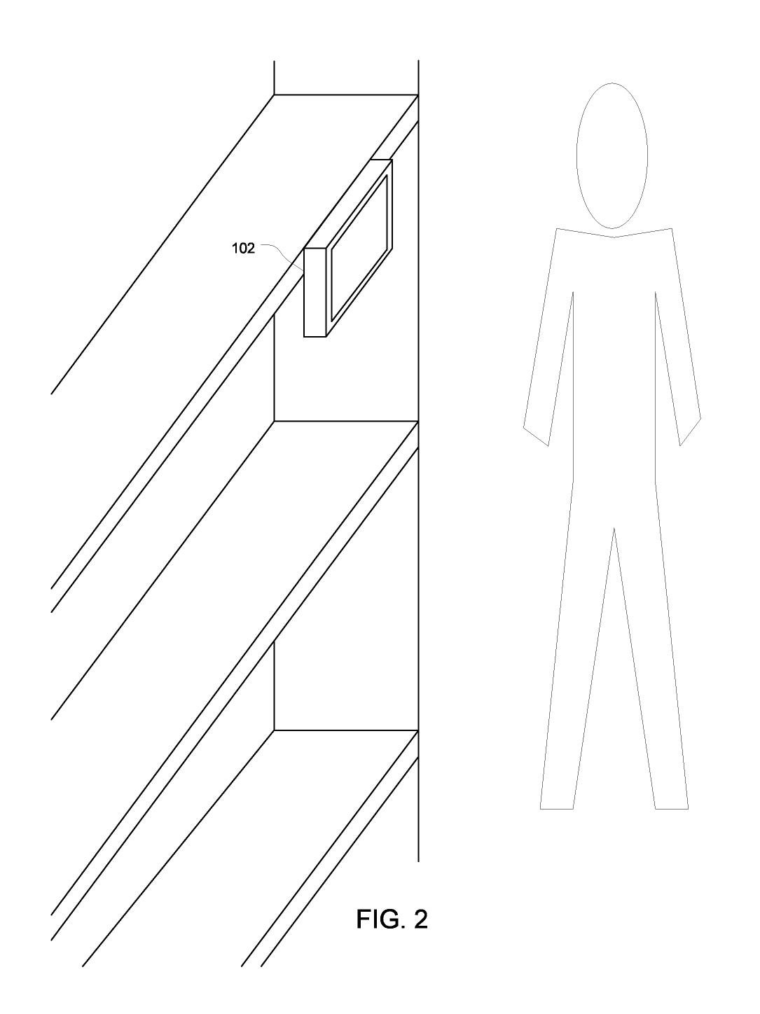

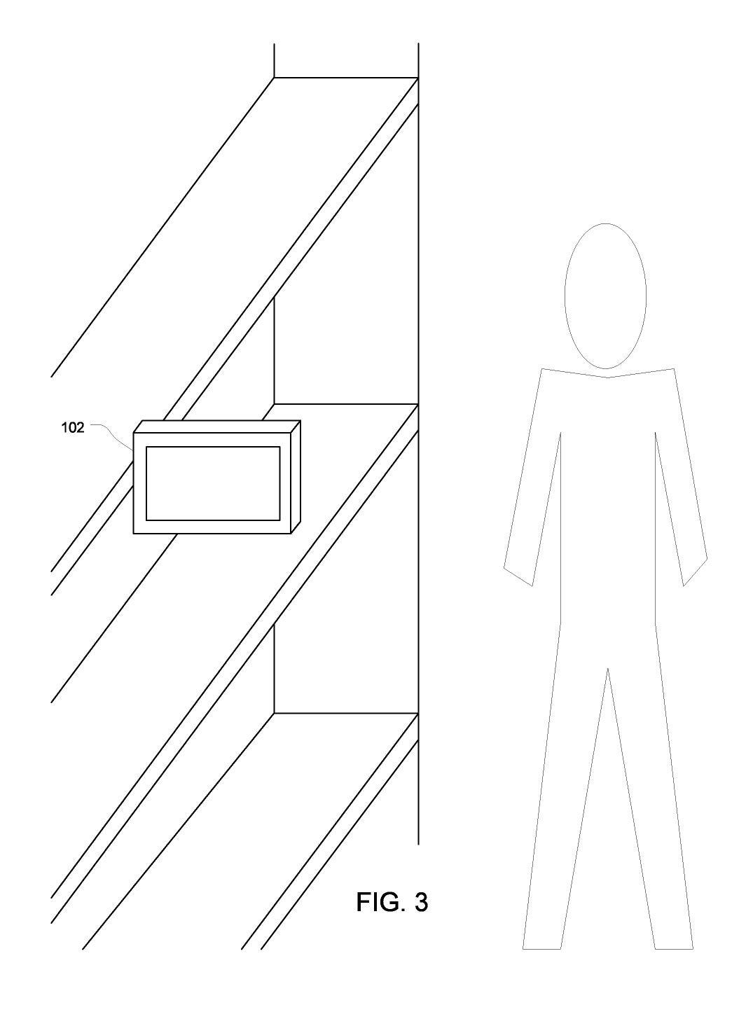

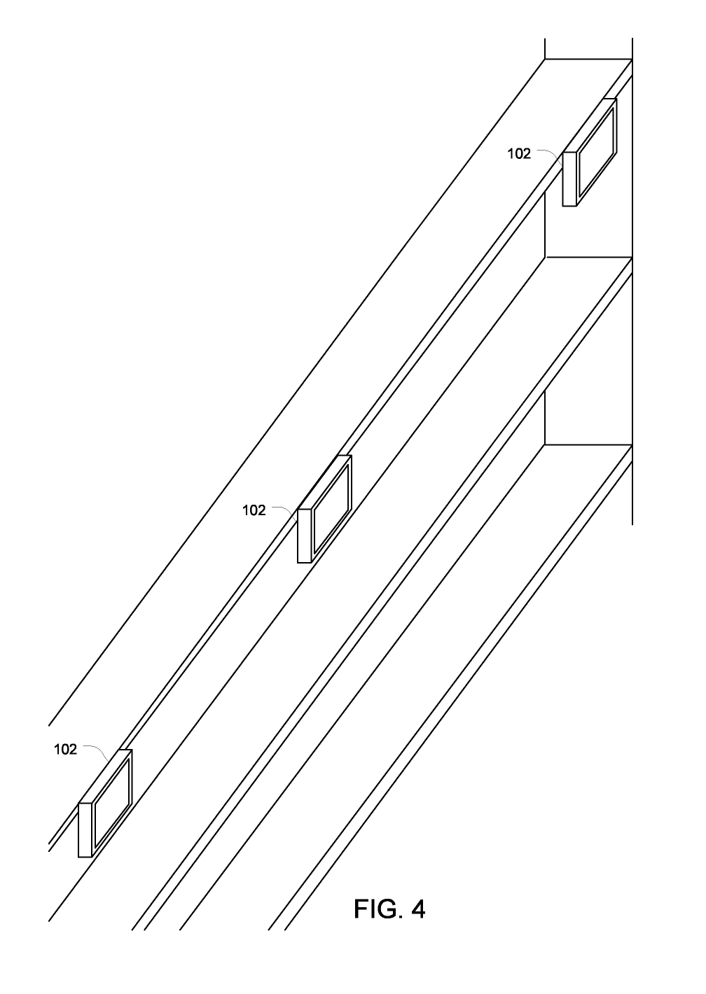

FIGS. 2 and 3 illustrate two exemplary embodiments in which display 102 can be used to display customized content to customers is a store. FIG. 2 illustrates display 102 being flush mounted to a shelf, whereas FIG. 3 illustrates display 102 being perpendicularly mounted to a shelf. As shown in FIG. 4, any reasonable number of displays 102 can be positioned on an aisle of a store, or at other locations within a store. Further, as described below, computer system 101 can correlate the content that is displayed on multiple displays 102.

According to some embodiments of the present invention, the invention may comprise systems and methods for advertising in stores through the use of video displays that can present customized advertisements when a customer is recognized as being in proximity of the video display.

For example, display 102 can present customized and/or personalized advertisements when a customer is recognized as being within proximity of display 102. As stated above, this recognition can be performed by one or more proximity sensors 103 capable of detecting the location of the customer relative to display 102.

When a customer is detected as being within a specified proximity of display 102, computer system 101 can present content that may catch the customer's attention and may help to increase sales. Suitable content includes advertising information, discount and pricing information, program and preview messages, promotional campaigns, general information, such as news, traffic, and/or weather, video and/or audio streaming media, or real-time footage of the customer.

For example, display 102 can display advertisements of a particular vendor. These advertisements can be selectively modified and customized based on which customer or customers are detected as being within the specified proximity of display 102. For example, the customized advertisement that is presented to the customer can be selected from a group of advertisements as the advertisement most likely to affect the customer's purchase decision. In another example, the customized advertisement is modified to reference the customer, products or types of products that the customer is known to purchase, or other things that the customer is known to appreciate or notice.

For example, sensor 103 can detect the presence of a detectable item 104 carried by the customer and output an identifier of the customer to computer system 101. Using the identifier of the customer, computer system 101 can access stored information about the identified customer and customize the content for display on display 102.

Computer system 101 can store various types of information about a customer such as information relating to a customer's identity (e.g. name, address, birthdate, age, sex, marital status, children, health, photographs of or relevant to the customer, or any type of preference), a customer's loyalty card or other identifier (e.g. an identifier of a mobile device or card), or a customer's account (e.g. purchase history). Any combination of this and other information can be used to customize content for display.

For example, it can be determined that a customer within the specified proximity of display 102 purchases two gallons of milk each time she is in the store. In response, an advertisement for milk can be displayed on display 102. In another example, it can be determined that a customer is a 50-year-old male. In response, an advertisement directed towards males in their 40s and 50s can be displayed. In still another example, it can be determined that a customer frequently purchases high-end brand products. In response, an advertisement of high-end products can be displayed. In yet another example, it can be determined that a customer's wife has an upcoming birthday. In response, an advertisement of potential gifts, flowers, or cards (or possibly a reminder of the upcoming birthday) can be displayed to the customer.

In some embodiments, computer system 101 can control displays 102 in multiple stores included stores of different chains. For example, computer system 101 can control the content that is displayed on displays 102 in a Kroger store and displays 102 in a Costco warehouse.

In such embodiments, computer system 101 can provide logically separate databases for each store or chain to maintain the security of purchase history and other account information that may be maintained by each individual store for a customer. In some cases, a network of displays 102 can be maintained that allows advertisers (e.g. manufacturers, store owners, etc.) to purchase display time on any number of displays 102 in a network. In some embodiments, the network can be implemented as an auction that allows the advertisers to bid on the available display time on any of the displays 102.

When an advertiser obtains display time for an advertisement or other content, the advertisement can be customized based on information stored about a customer in proximity of the selected display 102. For example, if the display is located within a Kroger, customer information maintained by Kroger can be used to customize the content for display.

Alternatively, a central database of information can be maintained that includes customer information compiled from purchase history or other information obtained across many stores. In such cases, when an advertiser obtains display time on a display, all information obtained about a customer in proximity of a selected display can be used to customize an advertisement (e.g. the customer's purchase history at Kroger, Costco, Target, etc.). In other words, even if the display 102 is located within Kroger, customer information obtained by Kroger, Costco, Target, etc. can be used to customize the content for display within the Kroger store. The amount of information available to customize content can be a configurable option when purchasing display time (e.g. a higher price can be paid for the use of more customer information).

Content for display on a display 102 can be customized in virtually any way. In some embodiments, the content can be customized by including one or more images that are relevant to a customer in proximity of the display. For example, a photograph of the customer can be displayed in conjunction with other content. The use of the customer's image or another image that is unique to the customer can attract the customer's attention to the video display and make the advertisement more noticeable and effective.

Photographs or other images of or related to a customer can be obtained in various ways. For example, the photograph can be submitted by the customer, acquired from an online source (e.g. Facebook), obtained within the store (e.g. via a camera located in the store such as in proximity to the display). Alternatively, an image such as an icon, logo, or photo can be selected by the customer. Example images can include an image of the customer's pet, the logo of the customer's favorite sports team, or a picture of a celebrity or cartoon character that the customer likes.

The image or photograph can be juxtaposed onto the advertisement, placed beside the advertisement, or otherwise incorporated into the advertisement. In some embodiments, the image can be a photo of the shopper that has been modified. For example, the image can be modified by changing the customer's hair color or facial feature in a manner that is likely to attract the customer's attention.

In some embodiments, instead of including an image in the customized content, text, names, or phrases can be included. For example, a customized advertisement can include the name of the customer. In another example, the customized advertisement can mention specific hobbies, pastimes, foods, or other items that are preferred by the customer.

In some embodiments, content can be customized using an avatar as a graphical image of a person or other character that can move around, talk to the customer, and/or interact with the customer on one or more displays 102. In some instances, an avatar can be customized, chosen by, or assigned to each customer. Moreover, in some embodiments, the avatar can be customizable such that it takes on physical attributes that are selected by the customer or provided by the system. For example, the customer can customize the physical attributes of the avatar and/or select the avatar from a set of preconfigured characters. In some instances, the avatar can look like a famous actor, actress, athlete, politician, or comedian. The avatar can also look like a cartoon character that looks like, sounds like, and moves like a cartoon character on television or in the movies. The avatar can also be an animal, reptile, fish, alien, or other such character.

In some embodiments, the physical characteristics of the avatar can be optimized over time based on the customer's response to the avatar. As such, the avatar can initially have a generic base. This generic base can have the appearance of an ordinary male or female, or a specific personality, such as the store founder. As the customer interacts or fails to interact with the avatar (e.g. following a recommendation to purchase a product, stopping to view the advertisement, moving towards the display, etc.), the generic base can be modified to attempt to influence the customer to perform a desired activity.

For example, if it is determined that the user does not respond well to an avatar having the voice of a male, the avatar can be changed to include the voice of a female, or the voice of a child. Similarly, the color of the avatar's hair, eyes, skin, or other such physical features can be adjusted over time. For example, if the customer is a young mother, the system may customize the avatar to have the appearance and voice of a young, well-behaved child.

In some embodiments, the avatar can function as a host or sales associate that greets the customer and guides the customer through the store while talking to the customer and/or answering the customer's questions. For example, when a customer enters the store, an avatar can greet the customer and ask if he needs any help finding anything. If the customer needs help finding a product within the store or learning about a product, the customer can ask the avatar a question. If the customer does not need help, avatar can disappear, continue to talk with the customer, or remain visible but silent. Thus, in some configurations, the avatar is controlled by an artificial intelligence system that enables the avatar to communicate and carry on a conversation with the customer. The avatar can make product recommendations to the customer and thus act as a means for providing customized advertisements to the customer. The avatar can provide the customer with information and/or answer the customer's questions by accessing a database of information about products, store inventory, and product details.

The avatar can be displayed on a display 102 that is proximate to the associated customer. As the customer moves through the store, the avatar can be displayed on other displays 102 that become proximate to the customer. Alternatively, the avatar can appear on a display 102 only in response to a specific request from the customer.

In a specific example, a 40-year-old male customer may have a customized avatar in the form of his favorite professional basketball player. The avatar can have the likeness and voice of the professional basketball player as well as the same speech patterns. The avatar can discuss the recent basketball game that the professional basketball player played in or ask the customer questions about himself. The avatar can then follow the customer around the store answering questions, advertising products, or talking with the customer. The avatar may disappear if the customer is not interested in his help or the avatar may silently follow the customer around the store by appearing in the displays 102 near the customer as the customer moves throughout the store.

In some embodiments, the image of the avatar or other custom image can be displayed as moving between adjacent displays 102 such as with a kinetically consistent motion. For example, computer system 101 can calculate the amount of time required for the avatar to travel between two displays 102 at a specific speed (e.g. a customer's current speed, an average customer speed, the speed at which the avatar is moved along a display, etc.), an move the display of the avatar from the first to the second display as if the avatar were physically travelling between the two displays.

In some embodiments, the content that is displayed can include transitional content for providing a realistic transition of the avatar from one display to the next. For example, a portion of a wall may be displayed at the edge of a first display. The avatar can be shown as passing behind the wall in the direction of the next display. Then, on the next display, an opposite end of the wall can be displayed on the display from which the avatar reemerges.

Some embodiments comprise augmented reality avatars or other images that travel between sequential video displays based on an actual floor plan of a store. Thus, the image can guide the customer through the store by traveling along aisles or other physical pathways through the store, rather than jumping from aisle to aisle or passing through other such physical barriers. In this way, the image or the avatar 96 can guide or follow the customer through the store in order to effectively provide continuous, customized advertisements and information to the customer.

Accordingly, in some embodiments a system includes a map or layout of the store that identifies the location of physical barriers within the store. The system can also include a set of pathways that go through the store between each of the displays. These pathways can identify the shortest paths from any given point in the store to any other given point. An avatar can use these pathways to guide a customer to a desired location within the store. For example, a customer at the entrance of the store may ask an avatar on a display screen near the entrance of the store to guide him to replacement blades for his razor. The avatar can then guide the customer along a predetermined pathway to the replacement blades. As the customer walks along the pathway, the avatar can give verbal directions to the customer as the avatar appears and then disappears on the sequential displays 102 along the pathway.

In some embodiments, the customized content displayed to a customer can include customized offers. For example, an offer for a flat-rate subscription for a particular item can be presented to a customer that frequently purchases the item. If a customer within proximity of a display 102 is determined, for example, to purchase one gallon of milk each week, an offer can be displayed for a flat rate subscription that provides one gallon of milk per week for a specified time period at a discounted price. In some embodiments, an offer for a flat rate subscription can include an option to have the item automatically shipped to the customer.

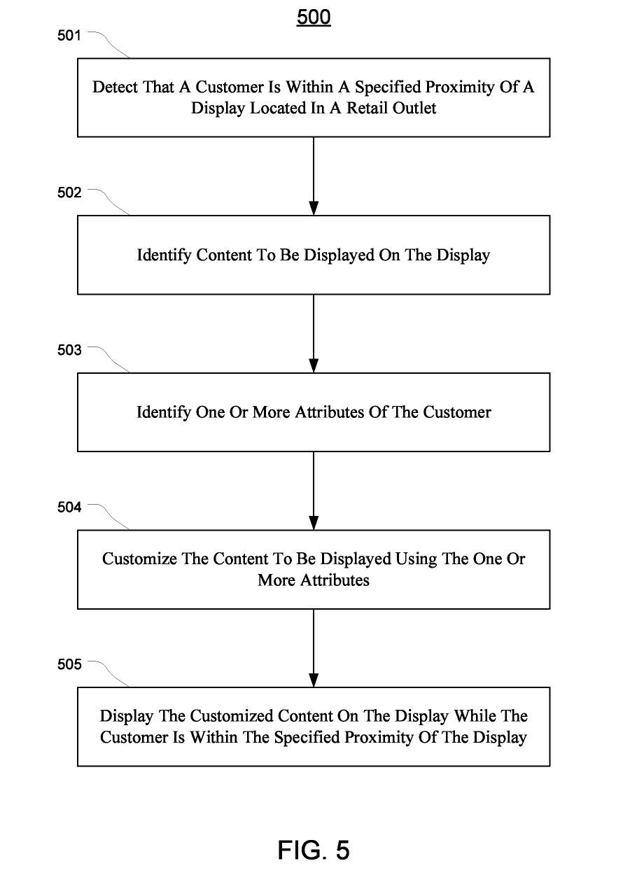

FIG. 5 illustrates a flowchart of an exemplary method 500 for displaying customized content on a display in a retail outlet. Method 500 will be described with reference to the figures.

Method 500 includes an act 501 of detecting that a customer is within a specified proximity of a display located in a retail outlet. For example, one or more proximity sensors 103 can detect the presence of a customer such as by detecting the customer's mobile device or card.

Method 500 includes an act 502 of identifying content to be displayed on the display. For example, computer system 101 can identify an advertisement or other content that is to be displayed on the display.

Method 500 includes an act 503 of identifying one or more attributes of the customer. For example, computer system 101 can identify an account of the customer that includes identity information, preference information, purchase history information, etc. of the customer.

Method 500 includes an act 504 of customizing the content to be displayed using the one or more attributes. For example, computer system 101 can customize the advertisement or other content to be displayed based on one or more attributes of the customer so that the content is likely to be more appealing to the customer.

Method 500 includes an act 505 of displaying the customized content on the display while the customer is within the specified proximity of the display. For example, computer system 101 can output a video stream to display 102 that includes the customized content so that the customized content is displayed on display 102 while the customer is within the specified proximity of display 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a computer system, for displaying customized content on a display in a retail outlet, the method comprising:
detecting that a customer is within a specified proximity of a display located in a retail outlet;
identifying content to be displayed on the display;
identifying one or more attributes of the customer;
customizing the content to be displayed using the one or more attributes; and
displaying the customized content on the display while the customer is within the specified proximity of the display.

2. The method of claim 1, wherein detecting that the customer is within the specified proximity of the display comprises detecting that a portable electronic device carried by the customer is within the specified proximity

3. The method of claim 2, wherein the portable electronic device comprises a mobile phone.

4. The method of claim 1, wherein detecting that the customer is within the specified proximity of the display comprises detecting that a card carried by the customer is within the specified proximity.

5. The method of claim 4, wherein the card comprises a loyalty card, a credit card, or an RFID card.

6. The method of claim 1, wherein the identified content to be displayed comprises one or more of: advertising content, discount or pricing information, program or preview messages, or promotional campaigns.

7. The method of claim 1, wherein the one or more attributes of the customer are selected from the following:
an identity of the customer;
preferences of the customer; or
purchase history of the customer.

8. The method of claim 1, wherein customizing the content to be displayed comprises including an image of or related to the customer with the content.

9. The method of claim 1, wherein customizing the content to be displayed comprises including an avatar customized for the customer with the content.

10. The method of claim 9, wherein the avatar is customized for the customer based on the customer's previous interactions with the avatar.

11. The method of claim 9, wherein the avatar is customized for the customer based on the identity of the customer.

12. The method of claim 9, wherein the avatar is customized for the customer based on the preferences of the customer.

13. The method of claim 9, wherein the avatar is customized for the customer based on purchase history of the customer.

14. The method of claim 13, wherein the purchase history comprises purchase history at multiple different stores.

15. The method of claim 1, further comprising:
detecting that the customer has moved within a specified proximity of a second display; and
displaying the customized content on the second display while the user is within the specified proximity of the second display.

16. The method of claim 15, wherein the display and the second display are positioned a certain distance apart, and wherein the customized content is displayed on the second display after a determined duration of time after the customized content is removed from the display to thereby give the appearance that the customized content is moving from the display to the second display at a certain rate.

17. The method of claim 15, wherein the customized content is displayed on the second display to guide the customer to a particular location within the retail outlet.

18. A system for displaying customized video content to a customer when the customer is within proximity of a display in a retail outlet, the system comprising:
a computer system storing content for display on any of a plurality of displays in one or more retail outlets and attributes for a plurality of customers;
the plurality of displays; and
a plurality of sensors for detecting the presence of customers when the customers are within a specified proximity of a display;
wherein the computer system further stores computer executable instructions which when executed perform the following to display customized content to a customer:
receiving data from one or more of the plurality of sensors, the data identifying that a customer is within a specified proximity of a first display of the plurality of displays;
using the data to identify one or more attributes of the customer;
using the one or more attributes to customize content for display on the first display; and
sending the customized content to the first display such that the customized content is displayed to the customer while the customer is within the specified proximity of the first display.

19. The system of claim 18, wherein the stored computer executable instructions further perform the following:
receiving data from one or more of the plurality of sensors, the data identifying that the customer is within a specified proximity of a second display; and
sending the customized content to the second display such that the customized content is displayed to the customer while the customer is within the specified proximity of the second display.

20. The method of claim 18, wherein the customized content comprises one or more of:
an image of the customer;
an image associated with the customer;
an avatar customized for the customer;
an offer customized for the customer; or
an advertisement customized for the customer.
